(19) United States
(12) Patent Application Publication
(10) Pub. No.: US 2015/0209667 A1
(43) Pub. Date: Jul. 30, 2015

(54) APPLICATION FAILURE MANAGEMENT IN COMPUTER- IMPLEMENTED ONLINE GAMES

(71) Applicant: Zynga Inc., San Francisco, CA (US)

(72) Inventors: Joshua Marc Burgin, Seattle, WA (US); Roland O'Leary, Kitchener (CA)

(73) Assignee: Zynga Inc., San Francisco, CA (US)

(21) Appl. No.: 14/230,705

(22) Filed: Mar. 31, 2014

Related U.S. Application Data
(60) Provisional application No. 61/931,018, filed on Jan. 24, 2014.

(51) Int. Cl. A63F 13/28

(52) U.S. Cl. CPC A63F 13/28

(57) ABSTRACT

Disclose methods and systems provide for management of game failure in distributed gaming by automated indication of a failure acknowledgment to a client device on which an associated player plays the game, for example by automatically presenting a failure apology message on the client device. An automated interactive acknowledgment process can include providing in-game compensation to the player, thereby to lessen player frustration resulting from game failures. The automated acknowledgment interaction can include gathering failure information from the client device.

### RELATED APPLICATION

This application claims the benefit of priority under 35 U.S.C. §119(e) of U.S. Provisional Patent Application Ser. No. 61/931,018 filed on Jan. 24, 2014, which is incorporated by reference herein in its entirety.

### TECHNICAL FIELD

This disclosure relates to games and applications in general, and also to computer-implemented online games, such as online role-playing games (RPGs) that are playable by more than one person from more than one location.

### BACKGROUND

Implementation of distributed games (e.g., massively multiplayer online games) often comprises cooperative execution of distributed software modules on physically distributed and configurationally variable hardware platforms. As a result, occasional interruptions or disturbances in game play due to malfunction or failure of one or more application components of a distributed application executing the game is an unfortunate reality of real-world online game implementation.

Failure events may be experienced by a player as a complete failure (e.g., crashing) of the application executing the game, or they may be experienced as a partial failure of the application (e.g., crashing or malfunction of one or more application components), resulting in a unavailability or malfunctioning of one or more in-game functionalities or features. Partial game failures can thus occur without a system or application crash, for example comprising malperformance of particular functions, poor performance (e.g., slow or sluggish execution of game actions), or loss of player-specific game state information.

### BRIEF DESCRIPTION OF THE DRAWINGS

Example embodiments of methods and systems are illustrated by way of example, and not limitation, in the figures of the accompanying drawings, in which like reference numerals indicate the same or similar elements unless otherwise indicated.

FIG. 1 illustrates an example of a system for implementing particular disclosed embodiments.

FIG. 2 illustrates an example social network.

FIG. 3 illustrates an example system for managing application failure in a computer-implemented online game, in accordance with an example embodiment.

FIG. 4 depicts a flowchart illustrating an example method for managing application failure in a computer-implemented online game, according to an example embodiment.

FIG. 5 illustrates a schematic view of a mobile electronic device on which an online game may be played, the mobile electronic device having a display screen for displaying in-game action and graphical user interfaces.

FIGS. 6A-6D are respective schematic views of example interactive graphic user interface (GUI) elements that may automatically be displayed to a player responsive to game failure.

FIG. 7 illustrates an example data flow in a system.

FIG. 8 illustrates an example network environment.

FIG. 9 illustrates an example computer system architecture.

### DESCRIPTION OF EXAMPLE EMBODIMENTS

Example embodiments described below with reference to the figures disclose a method and system to manage game failure in distributed gaming by automated acknowledgment of the failure. The automated acknowledgment may include providing an in-game compensation to the player because of the failure, which may serve to lessen player frustration resulting from game failures. Instead, or in addition, the automated interaction may be to gather information about the relevant failure.

The method may comprise, in response to a game failure event, causing automatic display on a client device of a failure acknowledgment message. The failure acknowledgment message may include an apology for the game failure event. The failure acknowledgment message may form part of an interactive failure acknowledgment process automatically triggered upon detection of the game failure event.

In some embodiments, the failure acknowledgment process may include providing a failure compensation or bonus to the player in response to game failure. In this context, the compensation or bonus means an in-game benefit which is unearned during normal gameplay (i.e., during non-failure execution of the game) by the player based on the applicable game rules/mechanics, with reference to game state information on record.

Note that in some instances, in-game assets and/or achievements that were gained by the player, but which are not reflected in post-failure game state information, may be restored to the user in the failure acknowledgment process. If, for example, the player purchases one or more in-game assets with in-game currency, but the game crashes before their newly acquired in-game assets are recorded in the game state information, it can happen that the player's account or virtual currency balance is reduced by the purchase amount even though the purchased assets are not reflected in the game state information. In such a case, provision of the purchased assets to the player is an example of providing a failure compensation to the player. This is because, based on the (erroneous) game state information on record, the relevant assets are not due to the player.

In some embodiments, the failure compensation may comprise a globally applicable failure bonus that is automatically credited to respective players responsive to associated game failures. Such a failure bonus is described as being globally applicable because it is automatically credited to any player suffering a game failure, irrespective of whether or not actual in-game loss has been suffered.

In one embodiment, the failure bonus may have a fixed in-game value for a particular type of failure, for example comprising a consistent, predefined number of in-game credits or virtual currency for game crashes. The failure bonus may in such cases be described as having a globally uniform value, in that the failure bonuses paid to different players are identical in value, regardless of the particular game state information and/or player attributes applying to the different players. Each game crash instance in such cases automatically triggers the offering or the award of a fixed-value crash compensation to the respective player.

In other embodiments, the quantum of the automatically provided failure bonus may be variable based on one or more factors or attributes specific to the relevant player, and/or specific to the relevant failure event. In one example, the value of the failure bonus may be automatically variable based on the player's failure history, to prevent profitable abuse of the compensation system by intentional player-induced application failures. For example, a limit may be placed on the number of crash compensation credits within a particular time period. Instead, or in addition, the value of crash compensation credits may decrease progressively based on the number of crashes, or based on crash frequency.

Note that although the failure acknowledgment process may in some instances restore or undo, at least to some extent, in-game damage or loss suffered owing to the game failure, the failure compensation may instead, or in addition, be provided as a valuable token of apology. The particular value of the failure compensation may thus be divorced from any actual damage or loss suffered by the player, so that actual in-game damage/loss may be irrelevant to the quantum of the failure compensation.

The interactive failure acknowledgment process may include collecting failure data representative of system parameters associated with the corresponding game failure. Note that the term “failure data” encompasses both malfunction data pertaining to a partial failure, and crash data pertaining to a complete application failure.

In some embodiments, the failure data may be collected automatically, without user input pertaining specifically to collection of the failure data. Instead, collection of the failure data may comprise causing display of a data-gathering option on a respective client device, with collection of the data being conditional on player-selection of the data-gathering option. In such cases, crediting of the failure bonus to the player may be conditional upon player-selection of the data-gathering option. The failure bonus or compensation may thus be provided as an incentive for sharing failure data. Failure data thus collected may be fed back to the game to help discover and fix technical issues leading to associated game failures.

The failure acknowledgment process may be provided as a real-time user experience, with the acknowledgment process being launched substantially immediately upon recognition of the relevant game failure. In some embodiments, communications forming part of the failure acknowledgment process may be displayed on the player device in an on-screen location used at other times for displaying targeted advertisements or promotions. In one example, a shared ad-targeting platform is used for on-screen display of (a) advertisements/promotions, and (b) user interface elements forming part of the interactive failure acknowledgment process.

A system for game failure management may be configured to seed the targeting platform with customer experience data. This customer experience data can be communicated to a game server (a) by respective client devices during game play (e.g., as part of API calls), (b) by server-side injection (e.g., into a targeting platform backend), and/or (c) by uploading into the targeting platform backend as part of a one-off or ad hoc job performed after the event of the respective game failure.

The method may include automated customization of the failure compensation based on player-specific information. The system may thus include decision logic to decide what kind of apology experience to provide to respective players based on the player-specific information. The decision logic may be configured to select a particular one of a plurality of failure compensation options. In instances where the failure compensation has a variable quantum, the decision logic may be configured to calculate the particular quanta of respective failure compensation, based at least in part on associated player specific information. The player-specific information of which the failure compensation value may be a function may include player attributes (e.g., game engagement level, game review behavior, social media activity level, in-game spending behavior, geographic location, gender, experience level, or the like), game state information, gameplay history, game review history, or the like. Instead, or in addition, the player-specific information which may affect parameters of the failure compensation may include information used in existing targeting algorithms, for example including demographic information, gamer history, in-game advertisement response history, promotional offer response history, and the like.

The player-specific information which may serve as a factor on which one or more properties of the failure compensation may be based may further comprise information about the type of failure experience suffered by the player. In such cases, the method may provide for a scale of predefined failure compensation values corresponding to a plurality of predefined failure types, so that the values of the failure compensations paid in different instances is type-specific.

In one embodiment, the method may include quantifying inconvenience experienced by the player because of the corresponding failure event. A complete game crash may, for example, have an inconvenience quotient which is greater than the inconvenience quotient for sluggish game performance. Similarly, a game crash that happens shortly after a latest save point may, for example, have an inconvenience quotient which is smaller than the quantifying inconvenience quotient for a game crash happening shortly before the next save point.

The player-specific information which may affect parameters of the failure bonus may further include information of in-game activity of the player at the time of the failure. If, for example, the player was (a) pursuing procurement of a particular in-game asset, or (b) pursuing achievement of a particular progress level, the failure bonus may be determined as (a) crediting the player with the particular in-game asset (or crediting the player with an as yet unachieved step towards procuring the particular in-game asset), or (b) crediting the player with achievement of the particular progress level (or crediting the player with an as yet unachieved step towards achieving the particular progress level). The player-specific information which may affect parameters of a failure bonus may further include information about specific in-game assets that would be useful to the player, or that are needed by the player, based on gameplay progress. If, for example, it is determined that the player has collected four out of a set of five objects needed for registering a specific in-game achievement, the failure bonus may comprise crediting the player with the specific one of the objects which the player has not yet collected.

The method may further include gathering feedback regarding the failure acknowledgment process, and dynamically adjusting decisional parameters used in automated performance of the failure acknowledgment process. In such cases, the feedback acknowledgment process is thus, at least to an extent, self-learning, being dynamically updated in response to user feedback.

### Example Game Environment

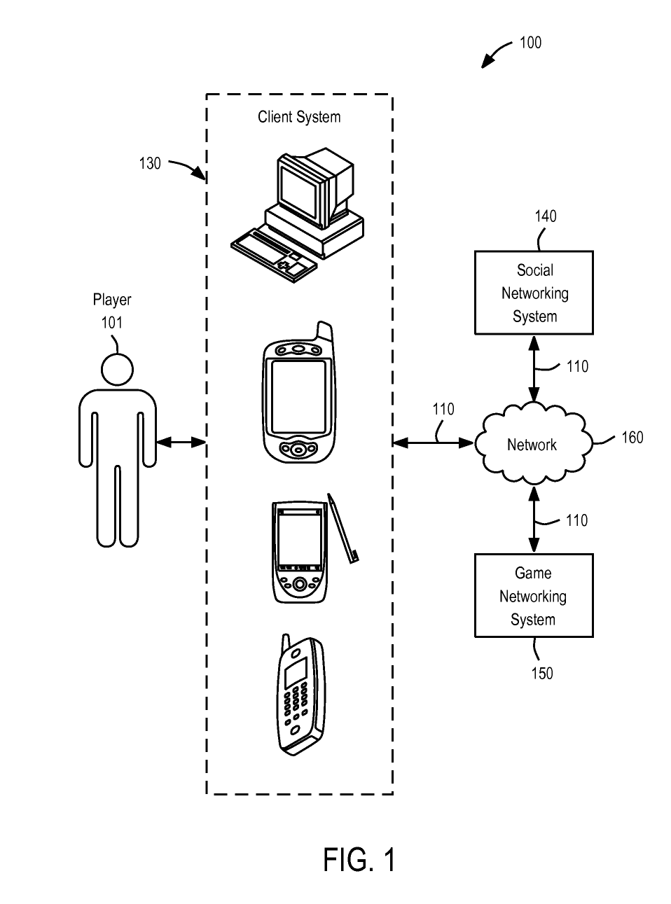

FIG. 1 illustrates an example of a system 100 for implementing various disclosed embodiments. In particular embodiments, system 100 comprises player 101, social networking system 140, game networking system 150, client system 130, and network 160. The components of system 100 can be connected to each other in any suitable configuration, using any suitable type of connection 110. The components may be connected directly or over a network 160, which may be any suitable network. For example, one or more portions of network 160 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another type of network, or a combination of two or more such networks.

Social networking system 140 is a network-addressable computing system that can host one or more social graphs. Social networking system 140 can generate, store, receive, and transmit social networking data. Social networking system 140 can be accessed by the other components of system 100 either directly or via network 160. Game networking system 150 is a network-addressable computing system that can host one or more online games. Game networking system 150 can generate, store, receive, and transmit game-related data, such as, for example, game account data, game input, game state data, and game displays. Game networking system 150 can be accessed by the other components of system 100 either directly or via network 160. Player 101 may use client system 130 to access, send data to, and receive data from social networking system 140 and game networking system 150. Client system 130 can access social networking system 140 or game networking system 150 directly, via network 160, or via a third-party system. As an example and not by way of limitation, client system 130 may access game networking system 150 via social networking system 140. Client system 130 can be any suitable computing device, such as a personal computer, laptop, cellular phone, smart phone, computing tablet, or the like.

Although FIG. 1 illustrates a particular number of players 101, social networking systems 140, game networking systems 150, client systems 130, and networks 160, this disclosure contemplates any suitable number of players 101, social networking systems 140, game networking systems 150, client systems 130, and networks 160. As an example and not by way of limitation, system 100 may include one or more game networking systems 150 and no social networking systems 140. As another example and not by way of limitation, system 100 may include a system that comprises both social networking system 140 and game networking system 150. Moreover, although FIG. 1 illustrates a particular arrangement of player 101, social networking system 140, game networking system 150, client system 130, and network 160, this disclosure contemplates any suitable arrangement of player 101, social networking system 140, game networking system 150, client system 130, and network 160. Note that the disclosed failure acknowledgment methods and systems may in some instances be implemented with respect to a single player game. In such cases, aspects relating to the game networking system 150 in the social networking system 140 are not episodes.

The components of system 100 may be connected to each other using any suitable connections 110. For example, suitable connections 110 include wireline (such as, for example, digital subscriber line (DSL) or Data Over Cable Service Interface Specification (DOCSIS)), wireless (such as, for example, Wi-Fi or Worldwide Interoperability for Microwave Access (WiMAX)) or optical (such as, for example, Synchronous Optical Network (SONET) or Synchronous Digital Hierarchy (SDH)) connections. In particular embodiments, one or more connections 110 each include an ad hoc network, an intranet, an extranet, a VPN, a LAN, a WLAN, a WAN, a WWAN, a MAN, a portion of the Internet, a portion of the PSTN, a cellular telephone network, another type of connection, or a combination of two or more such connections. Connections 110 need not necessarily be the same throughout system 100. One or more first connections 110 may differ in one or more respects from one or more second connections 110. Although FIG. 1 illustrates particular connections 110 between player 101, social networking system 140, game networking system 150, client system 130, and network 160, this disclosure contemplates any suitable connections between player 101, social networking system 140, game networking system 150, client system 130, and network 160. As an example and not by way of limitation, in particular embodiments, client system 130 may have a direct connection to social networking system 140 or game networking system 150, bypassing network 160.

### Game Networking Systems

In an online computer game, a game engine manages the game state of the game. A game state comprises all game play parameters, including player character state, non-player character (NPC) state, in-game object state, game world state (e.g., internal game clocks, game environment), and other game play parameters. Each player 101 controls one or more player characters (PCs). The game engine controls all other aspects of the game, including non-player characters (NPCs) and in-game objects. The game engine also manages game state, including player character state for currently active (online) and inactive (offline) players.

An online game can be hosted by game networking system 150, which can be accessed using any suitable connection 110 with a suitable client system 130. A player 101 may have a game account on game networking system 150, wherein the game account can contain a variety of information associated with the player 101 (e.g., the player 101's personal information, financial information, purchase history, player character state, and game state). In some embodiments, a player 101 may play multiple games on game networking system 150, which may maintain a single game account for the player 101 with respect to all the games, or multiple individual game accounts for each game with respect to the player 101. In some embodiments, game networking system 150 can assign a unique identifier to each player 101 of an online game hosted on game networking system 150. Game networking system 150 can determine that a player 101 is accessing the online game by reading the user's cookies, which may be appended to Hypertext Transfer Protocol (HTTP) requests transmitted by client system 130, and/or by the player 101 logging onto the online game.

In particular embodiments, player 101 may access an online game and control the game's progress via client system 130 (e.g., by inputting commands to the game at the client device). Client system 130 can display the game interface, receive inputs from player 101, transmit user inputs or other events to the game engine, and receive instructions from the game engine. The game engine can be executed on any suitable system (such as, for example, client system 130, social networking system 140, or game networking system 150). As an example and not by way of limitation, client system 130 can download client components of an online game, which are executed locally, while a remote game server, such as game networking system 150, provides backend support for the client components and may be responsible for maintaining application data of the game, processing the inputs from the player 101, updating and/or synchronizing the game state based on the game logic and each input from the player 101, and transmitting instructions to client system 130. As another example and not by way of limitation, each time player 101 provides an input to the game through the client system 130 (such as, for example, by typing on the keyboard or clicking the mouse of client system 130), the client components of the game may transmit the player 101's input to game networking system 150.

### Game Play

In particular embodiments, player 101 can engage in, or cause, one or more in-game actions. For a particular game, various types of in-game actions may be available to player 101. As an example and not by way of limitation, a player character in an online role-playing game may be able to interact with other player characters, build a virtual house, decorate the interior of a virtual house, attack enemies, go on a quest, and go to a virtual store to buy/sell virtual items. As another example and not by way of limitation, a player character in an online poker game may be able to play at specific tables, place bets of virtual or legal currency for certain amounts, discard or hold certain cards, play or fold certain hands, and play in an online poker tournament. Some online games have gameplay which does not include controlled activity of player characters in a virtual world. The automated provision of an interactive failure acknowledgment process can in some instances be provided for such games which have no graphically represented player characters, e.g., Words With Friends™ or analogous games.

In particular embodiments, player 101 may engage in an in-game action by providing one or more user inputs to client system 130. Various actions may specify various types and numbers of user inputs. Some types of in-game actions may call for a single user input. As an example and not by way of limitation, player 101 may be able to harvest a virtual crop by clicking on it once with a mouse. Some types of in-game actions may call for multiple user inputs. As another example and not by way of limitation, player 101 may be able to throw a virtual fireball at an in-game object by entering the following sequence on a keyboard: DOWN, DOWN and RIGHT, RIGHT, B. This disclosure contemplates engaging in in-game actions using any suitable number and type of user inputs.

In particular embodiments, player 101 can perform an in-game action on an in-game object or with respect to another player character. An in-game object is any interactive element of an online game. In-game objects may include, for example, player characters, NPCs, in-game assets and other virtual items, in-game obstacles, game elements, game features, and other in-game objects. This disclosure contemplates performing in-game actions on any suitable in-game objects. For a particular in-game object, various types of in-game actions may be available to player 101 based on the type of in-game object. As an example and not by way of limitation, if player 101 encounters a virtual bear, the game engine may give him the options of shooting the bear or petting the bear. Some in-game actions may be available for particular types of in-game objects but not other types. As an example and not by way of limitation, if player 101 encounters a virtual rock, the game engine may give him the option of moving the rock; however, unlike the virtual bear, the game engine may not allow player 101 to shoot or pet the virtual rock. Furthermore, for a particular in-game object, various types of in-game actions may be available to player 101 based on the game state of the in-game object. As an example and not by way of limitation, if player 101 encounters a virtual crop that was recently planted, the game engine may give him only the option of fertilizing the crop, but if player 101 returns to the virtual crop later when it is fully grown, the game engine may give him only the option of harvesting the crop.

In particular embodiments, the game engine may cause one or more game events to occur in the game. Game events may include, for example, a change in game state, an outcome of an engagement, completion of an in-game obstacle, a transfer of an in-game asset or other virtual item, or a provision of access, rights and/or benefits. In particular embodiments, a game event is any change in game state. Similarly, any change in game state may be a game event. As an example and not by way of limitation, the game engine may cause a game event where the virtual world cycles between daytime and nighttime every 24 hours. As another example and not by way of limitation, the game engine may cause a game event where a new instance, level, or area of the game becomes available to player 101. As yet another example and not by way of limitation, the game engine may cause a game event where player 101's player character heals one hit point every 5 minutes. Game events may include asynchronous social events, as described in greater detail herein.

In particular embodiments, a game event or change in game state may be an outcome of one or more in-game actions. The game engine can determine the outcome of a game event or a change in game state according to a variety of factors, such as, for example, game logic or rules, player character in-game actions, player character state, game state of one or more in-game objects, interactions of other player characters, or random calculations. As an example and not by way of limitation, player 101 may overcome an in-game obstacle and earn sufficient experience points to advance to the next level, thereby changing the game state of player 101's player character (e.g., it advances to the next character level). As another example and not by way of limitation, player 101 may defeat a particular boss NPC in a game instance, thereby causing a game event where the game instance is completed, and the player 101 advances to a new game instance. As yet another example and not by way of limitation, player 101 may pick the lock on a virtual door to open it, thereby changing the game state of the door (it goes from closed to open) and causing a game event (the player 101 can access a new area of the game).

In particular embodiments, player 101 may access particular game instances of an online game. A game instance is a copy of a specific game play area that is created during runtime. In particular embodiments, a game instance is a discrete game play area where one or more players 101 can interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables. A game instance may be exclusive (i.e., accessible by specific players) or non-exclusive (i.e., accessible by any player). In particular embodiments, a game instance is populated by one or more player characters controlled by one or more players 101 and one or more in-game objects controlled by the game engine. When accessing an online game, the game engine may allow player 101 to select a particular game instance to play from a plurality of game instances. Alternatively, the game engine may automatically select the game instance that player 101 will access. In particular embodiments, an online game comprises only one game instance that all players 101 of the online game can access.

In particular embodiments, a specific game instance may be associated with one or more specific players. A game instance is associated with a specific player when one or more game parameters of the game instance are associated with the specific player. As an example and not by way of limitation, a game instance associated with a first player may be named “First player's Play Area,” or “First player's Game Instance.” This game instance may be populated with the first player's player character and one or more in-game objects associated with the first player.

Such a game instance associated with a specific player may be accessible by one or more other players, either synchronously or asynchronously with the specific player's game play. As an example and not by way of limitation, a first player (i.e., the host player) may be associated with a first game instance, but the first game instance may be accessed by all first-degree friends in the first player's social network. As used herein, players thus accessing a game instance associated with another player are referred to as guest players, guests, visiting players, or visitors. In particular embodiments, the game engine may create a specific game instance for a specific player when that player accesses the game. As an example and not by way of limitation, the game engine may create a first game instance when a first player initially accesses an online game, and that same game instance may be loaded each time the first player accesses the game.

In particular embodiments, the set of in-game actions available to a specific player may be different in a game instance that is associated with that player (e.g., in which the player is a host player) compared to a game instance that is not associated with that player (e.g., in which the player is a guest player). The set of in-game actions available to a specific player in a game instance associated with that player may be a subset, superset, or independent of the set of in-game actions available to that player in a game instance that is not associated with him. As an example and not by way of limitation, a first player may be associated with Blackacre Farm in an online farming game. The first player may be able to plant crops on Blackacre Farm. If the first player accesses a game instance associated with another player, such as Whiteacre Farm, the game engine may not allow the first player to plant crops in that game instance. However, other in-game actions may be available to the first player, such as watering or fertilizing crops on Whiteacre Farm.

### Social Graphs and Social Networking Systems

In particular embodiments, a game engine can interface with a social graph. Social graphs are models of connections between entities (e.g., individuals, users, contacts, friends, players, player characters, non-player characters, businesses, groups, associations, concepts, etc.). These entities are considered “users” of the social graph; as such, the terms “entity” and “user” may be used interchangeably when referring to social graphs herein. A social graph can have a node for each entity and edges to represent relationships between entities. A node in a social graph can represent any entity. In particular embodiments, a unique client identifier can be assigned to each user in the social graph. This disclosure assumes that at least one entity of a social graph is a player or player character in an online multiplayer game, though this disclosure may apply to any suitable social graph user.

The minimum number of edges to connect a player (or player character) to another user is considered the degree of separation between them. For example, where the player and the user are directly connected (one edge), they are deemed to be separated by one degree of separation. The user would be a so-called “first-degree friend” of the player. Where the player and the user are connected through one other user (two edges), they are deemed to be separated by two degrees of separation. This user would be a so-called “second-degree friend” of the player. Where the player and the user are connected through N edges (or N−1 other users), they are deemed to be separated by N degrees of separation. This user would be a so-called “Nth-degree friend.”

Within the social graph, each player (or player character) has a social network. A player's social network includes all users in the social graph within Nₘₐₓ degrees of the player, where Nₘₐₓ is the maximum degree of separation allowed by the system managing the social graph (such as, for example, social networking system 140 or game networking system 150). In one embodiment, Nₘₐₓ equals 1, such that the player's social network includes only first-degree friends. In another embodiment, Nₘₐₓ is unlimited and the player's social network is coextensive with the social graph.

In particular embodiments, the social graph is managed by game networking system 150, which is managed by the game operator. In other embodiments, the social graph is part of a social networking system 140 managed by a third-party (e.g., Facebook, Friendster, Myspace). In yet other embodiments, player 101 has a social network on both game networking system 150 and social networking system 140, wherein player 101 can have a social network on the game networking system 150 that is a subset, superset, or independent of the player's social network on social networking system 140. In such combined systems, game networking system 150 can maintain social graph information with edge type attributes that indicate whether a given friend is an “in-game friend,” an “out-of-game friend,” or both. The various embodiments disclosed herein are operable when the social graph is managed by social networking system 140, game networking system 150, or both.

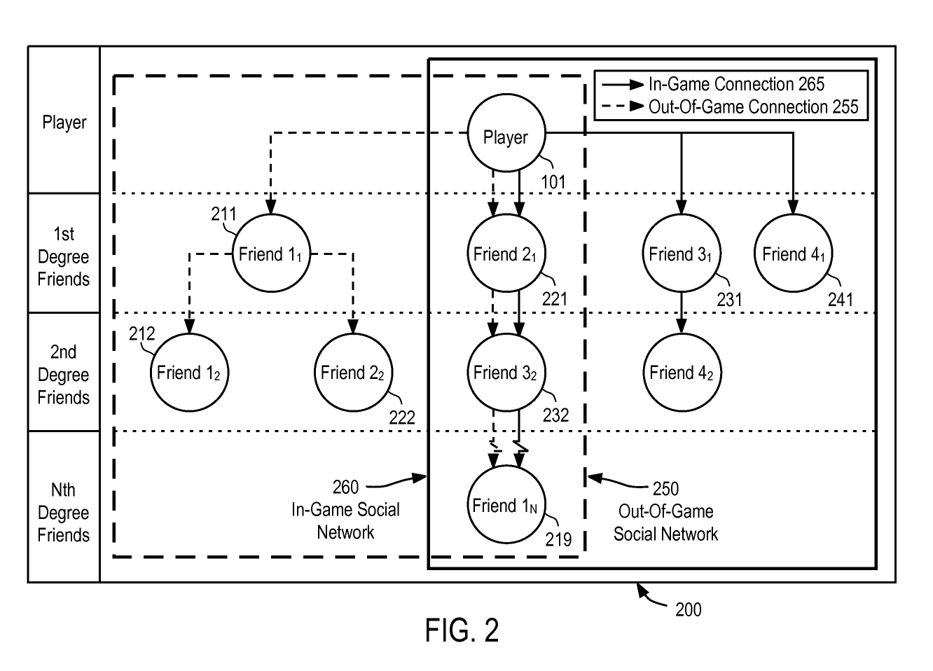

FIG. 2 shows an example of a social network within a social graph 200. As shown, player 101 can be associated, connected or linked to various other users, or “friends,” within the out-of-game social network 250. These associations, connections or links can track relationships between users within the out-of-game social network 250 and are commonly referred to as online “friends” or “friendships” between users. Each friend or friendship in a particular user's social network within a social graph is commonly referred to as a “node.” For purposes of illustration and not by way of limitation, the details of out-of-game social network 250 will be described in relation to player 101. As used herein, the terms “player” and “user” can be used interchangeably and can refer to any user in an online multiuser game system or social networking system. As used herein, the term “friend” can mean any node within a player's social network.

As shown in FIG. 2, player 101 has direct connections with several friends. When player 101 has a direct connection with another individual, that connection is referred to as a first-degree friend. In out-of-game social network 250, player 101 has two first-degree friends. That is, player 101 is directly connected to friend 1₁ 211 and friend 2₁ 221. In a social graph, it is possible for individuals to be connected to other individuals through their first-degree friends (i.e., friends of friends). As described above, each edge connecting a player to another user is considered the degree of separation. For example, FIG. 2 shows that player 101 has four second-degree friends to which he is connected via his connection to his first-degree friends. Second-degree friend 1₂ 212 and friend 2₂ 222 are connected to player 101 via his first-degree friend 1₁ 211. The limit on the depth of friend connections, or the number of degrees of separation for associations that player 101 is allowed, is typically dictated by the restrictions and policies implemented by social networking system 140 (FIG. 1).

In various embodiments, player 101 can have Nth-degree friends connected to him through a chain of intermediary degree friends, as indicated in FIG. 2. For example, Nth-degree friend 1_{N} 219 is connected to player 101 via second-degree friend 3₂ 232 and one or more other higher-degree friends. Various embodiments may benefit from of and utilize the distinction between the various degrees of friendship relative to player 101.

In particular embodiments, a player (or player character) can have a social graph within an online multiplayer game that is maintained by the game engine and another social graph maintained by a separate social networking system. FIG. 2 depicts an example of in-game social network 260 and out-of-game social network 250. In this example, player 101 has out-of-game connections 255 to a plurality of friends, forming out-of-game social network 250. Here, friend 1₁ 211 and friend 2₁ 221 are first-degree friends with player 101 in his out-of-game social network 250. Player 101 also has in-game connections 265 to a plurality of players, forming in-game social network 260. Here, friend 2₁ 221, friend 3₁ 231, and friend 4₁ 241 are first-degree friends with player 101 in his in-game social network 260. In some embodiments, it is possible for a friend to be in both the out-of-game social network 250 and the in-game social network 260. Here, friend 2₁ 221 has both an out-of-game connection 255 and an in-game connection 265 with player 101, such that friend 2₁ 221 is in both player 101's in-game social network 260 and player 101's out-of-game social network 250. As used herein, players forming part of the in-game social network 260 may also be referred to as “friend players.”

As with other social networks, player 101 can have second-degree and higher-degree friends in both his in-game and out-of-game social networks. In some embodiments, it is possible for player 101 to have a friend connected to him both in his in-game and out-of-game social networks, wherein the friend is at different degrees of separation in each network. For example, if friend 2₂ 222 had a direct in-game connection with player 101, friend 2₂ 222 would be a second-degree friend in player 101's out-of-game social network 250, but a first-degree friend in player 101's in-game social network 260. In particular embodiments, a game engine can access in-game social network 260, out-of-game social network 250, or both.

In particular embodiments, the connections in a player's in-game social network 260 can be formed both explicitly (e.g., users “friend” each other) and implicitly (e.g., system observes user behavior and “friends” users to each other). Unless otherwise indicated, reference to a friend connection between two or more players can be interpreted to cover both explicit and implicit connections, using one or more social graphs and other factors to infer friend connections. The friend connections can be unidirectional or bidirectional. It is also not a limitation of this description that two players who are deemed “friends” for the purposes of this disclosure are not friends in real life (i.e., in disintermediated interactions or the like), but that could be the case.

In multiplayer online games, two or more players can play in the same game instance. Game play is asynchronous when the players do not play simultaneously in the game instance. In particular embodiments, synchronous game play between two players in the same game instance can be simulated from asynchronous game play by recording the game play of a first player in the game instance at a first time and replaying that game play during the game play of a second player in the game instance at a later time. In particular embodiments, the game engine can record the in-game actions of a first player in a game instance for later play-back by other players in the game instance, and then the game engine loads and executes the previously recorded in-game actions during the game play of other players in the game instance.

### Example System

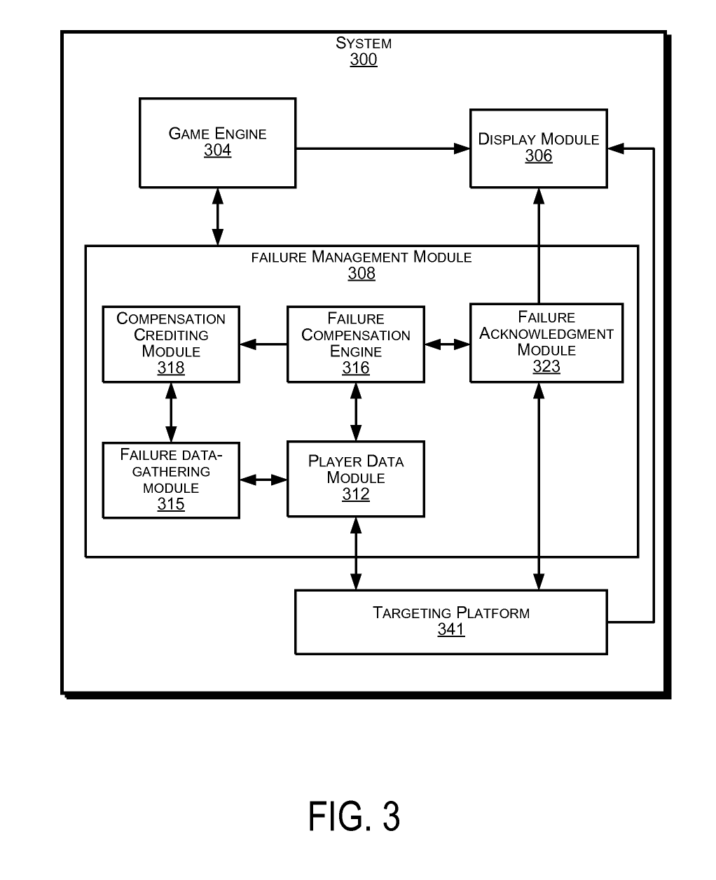

FIG. 3 illustrates an example system 300 for implementing particular disclosed embodiments. The system 300 may comprise a number of hardware implemented modules provided by one or more processors. The system 300 may include a game engine 304 to manage a multiplayer online game. To this end, the game engine 304 may include game logic to manage in-game objects and nonplayer character behavior, and to execute in-game actions responsive to user input. Although other illustrated modules of the system 300 are shown in FIG. 3 to be separate from the game engine 304, one or more of these modules may form part of the game engine module. As mentioned earlier, the system may in some embodiments be configured for at least optionally providing a single-player gaming experience.

The system 300 may further include a display module 306 to generate a game display for the computer-implemented game on a client system 130. The game display may be of a particular game instance associated with a particular player 101. The game display typically comprises an environment view that shows a virtual in-game environment of the particular game instance, and a graphical user interface to receive user input and to display game related information to the user.

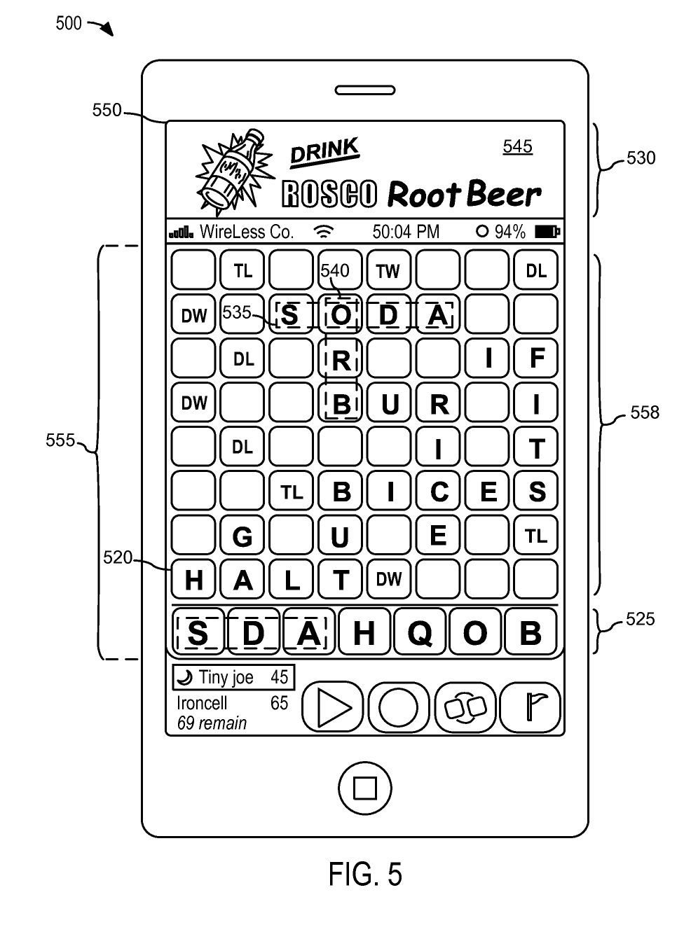

The system 300 further comprises a failure management module 308 configured to perform an automated failure acknowledgment process in response to occurrence of a failure event. The failure management module 308 may include a player data module 312 configured to gather player-specific data and/or failure event-specific data to be used in determining parameters of failure compensation that is to be credited to the player. In this embodiment, the system 300 includes a targeting platform 341 configured to provide targeted advertisements and/or promotional offers to the player during gameplay, in accordance with techniques that are well-established in the art (see, for example, advertisement 545 in FIG. 5). The targeting platform 341 may form part of an integrated in-game advertisement platform, for example such as the in-game advertisement platform described and illustrated in U.S. patent application Ser. No. 13/720,280, filed on Dec. 19, 2012 and titled “Presenting In-Game Sponsored Content Via A Single Interface,” which is incorporated herein in its entirety.

The player data module 312 may be configured to cooperate with the targeting platform 341, so that automated determination of a crash bonus or failure compensation by a failure compensation engine 316 may be based at least in part on player-specific data provided by the targeting platform 341. A compensation crediting module 318 may be configured to credit a player affected by a game failure with an in-game benefit calculated by the failure compensation engine 316, for example by adjusting a balance of an in-game virtual currency account, or by modifying game state data to provide the player with in-game assets, achievements, and/or progress levels.

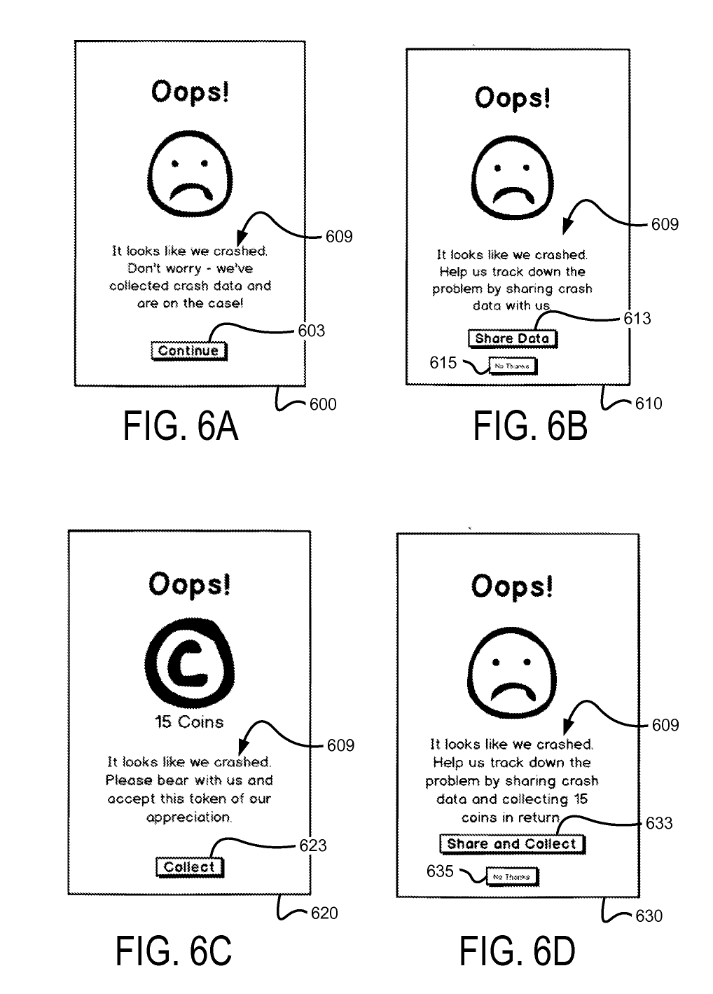

The system 300 may further include a failure acknowledgment module 323 to generate and cause display of one or more failure acknowledgment graphical user interfaces, some examples of which are described with reference to FIGS. 6A-6D. As described with reference to the example embodiments of FIGS. 3 and 5, the failure acknowledgment module 323 may be configured to display graphical user interface elements on a mobile electronic device using an advertisement platform, so that GUI elements for failure acknowledgment are displayed in the same screen position used for display of targeted advertisements and/or promotional offers by the targeting platform 341 (see, for example, ad banner 530 in FIG. 5).

The failure management module 308 may further comprise a failure data-gathering module 315 to collect failure data indicating forensic information related to the relevant failure event (e.g., crash data). In some instance, the failure data may be resident on a client device, with client permission being a prerequisite for gathering the failure data from the client device. In such instances, the failure data-gathering module 315 may be configured to gather the failure data from the client device only in response to user-selection of a data-gathering option or prompt displayed on the client device (see, for example, FIGS. 6B and 6D).

Functionality of the system 300 and its respective modules, in accordance with the example embodiment, is further described below with respect to example methods.

### Example Methods

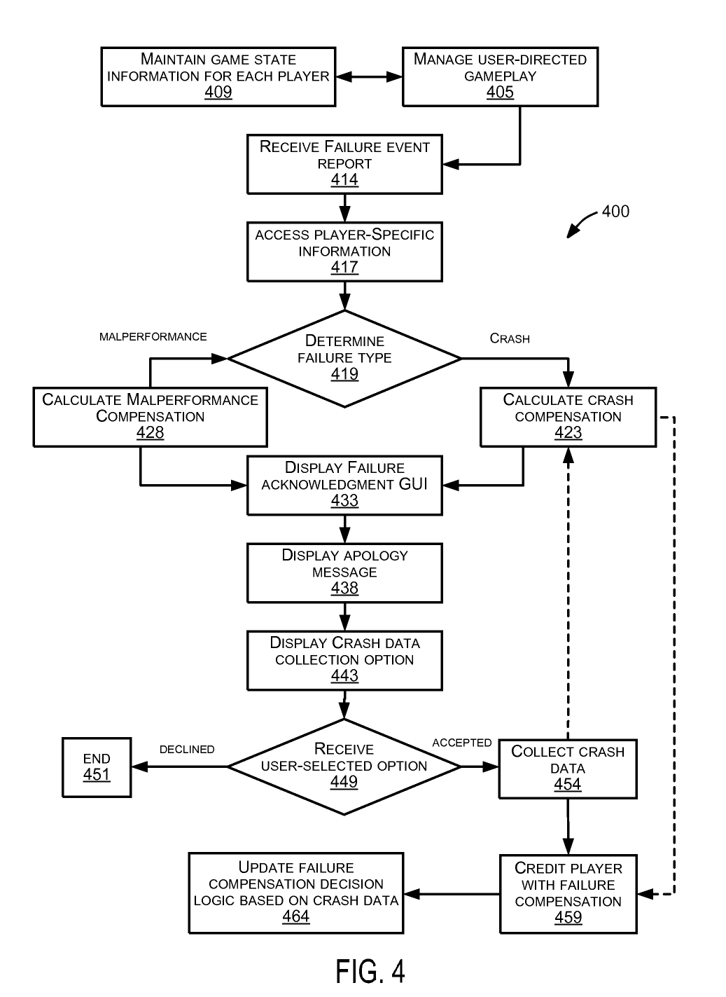

FIG. 4 shows a high-level flow chart of a part of an example method 400 to host a computer-implemented online game, which includes a method of managing application failure in the game. The method 400 may be implemented in one embodiment by example system 300, described above with reference to FIG. 3, in the game environment described with reference to FIGS. 1 and 2.

The method 400 comprises generating a game display for a particular game instance of a computer-implemented multiplayer game, and managing user directed gameplay, at operation 405, by receiving input from a player playing the game on a client system 130. In one example embodiment, the client system 130 may be a mobile phone, further referred to in this description as client device 130. An example mobile phone that may service as client device is illustrated in FIG. 5. During management of user-directed gameplay, game state information is continuously maintained and updated for the respective player, at operation 409.

At operation 414, a failure event report is received with respect to the relevant game instance. The failure event report may indicate occurrence of a failure event in an instance of the game played on the client device of an associated player. As mentioned previously, the failure event may be a complete application failure, in that the application executing the game has crashed. A game crash typically consists of sudden interruption of gameplay and closure of the game application, often without saving the latest in-game progress, and/or without providing the user with an option for saving the current game state. Instead, the failure event may be a partial game, resulting, for example, in malperformance and/or unavailability of some in-game actions or features, without the game crashing. In either case, the failure event comprises disturbance of normal gameplay by the player caused by malfunctioning of one or more application components executing the game.

Player-specific information may be accessed, at operation 417, responsive to the failure. The player-specific information may include historical information about in-game and other out-of-game behavior of the player. Customization information, for example, gathered by the targeting platform 341 may be included in the player-specific information. The player-specific information may further include game state information of the relevant player, for example indicating progress of the player in the game and/or indicating in-game assets of the player in the relevant game. The player-specific information may instead, or in addition, include information regarding the failure event, which may include the player's in-game behavior (e.g., the player's click stream) leading up to the failure event.

In this example embodiment, a failure compensation scheme provides for differentiated failure compensations for partial failure in which the game application exhibits non-crash malperformance (e.g., in which normal gameplay is disturbed by application malfunction, but without crashing the game), and for complete failure, in which the game crashes. In the description that follows, a malperformance compensation refers to an in-game asset, resource, or benefit provided to the player for non-crash malperformance, while a crash compensation refers to any in-game asset, resource, or benefit provided to the player following a game crash.

At operation 419, the relevant failure type is automatically determined. If the failure is a game crash or system crash, then the method 400 may include automatically calculating or determining the crash compensation, at operation 423. If, instead, the failure type is malperformance of the game, then the method 400 may include, at operation 428, automatically calculating a malperformance compensation. The calculation of the crash compensation or the malperformance compensation may be based at least in part on the player-specific information, so that the crash compensation, for example, is tailored to the particular crash instance and/or the corresponding player. Variations in the nature and quantum of the compensation may be as described above, for example being a universally applicable virtual currency bonus, being a custom amount of virtual currency calculated as a factor of the player-specific information, or being in-game assets specific to the player's in-game progress and/or achievements (e.g., specific in-game resources such as energy or extra lives, or specific in-game objects such as specific furniture in a game in which the gameboard is a residential.) Calculation of the relevant failure compensation (e.g., calculating the amount of a particular in-game asset or benefit, and/or calculating the particular type of in-game asset or benefit that is to be provided as failure compensation) may be performed by the failure compensation engine 316 (FIG. 3) based on failure compensation decision logic encoded in the failure compensation engine 316.

A failure acknowledgment GUI may thereafter be displayed, at operation 433. In this example embodiment, the failure acknowledgment GUI includes an acknowledgment communication in the example form of an apology, so that the method 400 includes, at operation 438, presenting an apology message on the client device 130 (see, for example, FIG. 6 and the discussion that follows). Note that the failure acknowledgment communication is configured to clearly convey to the player that it is a communication from the game or from an entity hosting the game (e.g., the particular company or corporation under whose name the game is published and/or that manages the game). This is to be distinguished from a system crash notification report, for example, generated by an operating system of the client device 130.

FIGS. 6A-D show a number of different example apology GUIs that may be provided in different embodiments, or in different instances of a particular embodiment. As can be seen, an apology GUI 600 of FIG. 6A includes a failure acknowledgment communication in the example form of the apology message 609. In instances where the apology GUI 600 of FIG. 6A is used, crash data is automatically collected, and no failure compensation bonus is awarded. The apology GUI 600 of FIG. 6A therefore acknowledges the failure by communicating to the player apologies for the crash, and informs the player that crash data has been collected and is being processed. The GUI 600 of FIG. 6A includes a soft button 603 that can be selected by the player (e.g., by clicking on it) to close the apology GUI 600 and continue.

The apology GUI 610 of FIG. 6B is analogous to the GUI 600 of FIG. 6A, but additionally provides the user with an option as to whether or not crash data is to be collected. It will be appreciated that failure data (in this case, crash data) often resides on the client device 130 and may not be retrieved by an outside system, such as a game server administering the game and providing the game system 300, without the permission of the device owner. The apology GUI 610 therefore communicates apologies for the crash and requests sharing of crash data, to assist with resolution of issues leading to the crash. The player can allow crash data collection by clicking a “Share Data” soft button 613, or can deny the request for crash data collection by clicking on a “No Thanks” soft button 615.

The apology GUI 620 of FIG. 6C is analogous to the GUI 600 of FIG. 6A, but additionally communicates the provision to the user of a crash compensation as a token of apology for the failure event. The acknowledgment communication 609 in the apology GUI 620 therefore comprises both an apology message and a compensation message indicating that provision of the failure compensation is as a result of the corresponding failure event. In this example, the crash compensation is an amount of 15 coins in the virtual in-game currency which is automatically credited to the account of the player responsive to clicking a “Collect” soft button 623. In the example of FIG. 6C, the 15 coins compensation is a fixed-value crash bonus which applies globally, and which is automatically credited to any player who experiences a game crash.

In the example embodiment described with reference to the flowchart of FIG. 4, the apology GUI 630 of FIG. 6D may be employed. This apology GUI 630 includes an apology message 609 and additionally offers a crash compensation that is conditional upon the sharing of crash data by the player. Returning now to FIG. 4, the method may thus include, at operation 443, displaying a failure data-gathering option to the player, and receiving the user-selected option, at operation 449, via the apology GUI 630 (FIG. 6D).

If the crash data-gathering option is declined (e.g., by selecting a “No Thanks” soft button 635 on the apology GUI 630), then the process ends, at operation 451. If, however, the crash data-gathering option is accepted (e.g., by player selection of a “Share And Collect” soft button 633 on the apology GUI 630), then the crash data is collected, at operation 454, and the player is credited with the relevant crash compensation or malperformance compensation, at operation 459.

Note that, in some embodiments, the failure compensation engine 316 (FIG. 3) is configured to calculate the crash compensation (at operation 423) based at least in part on attributes or factors available only from the crash data. In such cases, as indicated by the broken-line flow arrows in FIG. 4, the calculation of the crash compensation, at operation 423, may be performed (or may be revised) after collection of the crash data, at operation 454. One example of crash compensation that is dependent on the collection of crash data from the client device 130 comprises full or partial restitution of lost game progress or in-game assets to the user. By “lost” elements is meant progress or assets that result from gameplay by the user between a last saved game state and the relevant game crash. For example, it can happen that a player purchases an in-game object with in-game currency, but that the game crashes after the player's currency balance has been reduced, but before of the purchased object registers in the player's game state information. In such cases, information retrieved from the client device 130 (e.g., when the retrieved crash data includes information on the player's in-game actions or behavior, such as, for example a click stream) may be used by the failure compensation engine 316 to undo or at least ameliorate losses and/or frustration suffered by the user due to the crash. In the above-mentioned example, the failure compensation may, for example, comprise providing to the player the purchased object with which the player was not previously credited, due to the crash.

After the player has been credited with the relevant failure compensation, at operation 459, the failure compensation decision logic of the failure compensation engine 316 that may be used at operation 428 and/or at operation 423 to calculate failure compensation types/amounts may be automatically updated at operation 464. The collected crash data may also be communicated to an application management system for forensic use in resolving or ameliorating technical issues resulting in a crashing or failure of the game.

In some embodiments, the apology GUI 630 may be displayed on screen in a screen space in which targeted advertisements or offers are displayed during normal gameplay. One such example can be seen with reference to FIG. 5, which depicts a mobile device 500, such as a cell phone, engaged in an online game session as a client device. The mobile device 500 may incorporate a touch screen 550 to display images of game play and facilitate user interaction.

A main game play area 555 may display a primary game play board area 558, which may be a word game for example, where words may be spelled out from letter tiles 520 available from a tile rack 525. Each of two or more players may take turns spelling new words from their available letter tiles 520 where a new word includes at least one letter tile 520 associated with a previously played word to form the newly spelled word. A user may select a letter to play by applying a fingertip on the touch screen 550 over an available letter tile 520 in the tile rack 525. The letter tile 520 may then be dragged to an unoccupied tile position in the game play board area 558 while continuous contact is maintained with the finger on the touch screen 550.

During such gameplay, targeted advertisements 545 may be presented in an ad banner 530 in an upper portion of the touch screen 550. The content of the advertisement may in some embodiments be customized based on player-demographics, gameplay history, ad-interaction history, or the like. In the event of a game crash or significant game failure, an apology GUI, similar or analogous in content to those described with reference to FIG. 6, may be displayed in the ad banner 530. In such instances, targeted advertisement display and interactive apology processes (as described above) may be implemented by shared programmatic components, for example provided by the targeting platform 341 (FIG. 3). In one embodiment in which a common platform is used for target in-game advertisements and for the interactive apology processes, the apology GUIs (e.g., apology GUI 600-630 of FIG. 6) may be formatted to have a look and feel similar or identical to in-game user interfaces with which players interact during normal gameplay. Note that such consistency in visual appearance and or formatting of the apology GUIs may serve to convey to the player that the corresponding failure acknowledgment communication and/or failure compensation is from the relevant game host and is executed by the game application, not by another application such as, for example, the operating system of the client device.

It is a benefit of the failure acknowledgment process described with reference to the example embodiments that player frustration is, at least to some extent, lessened by acknowledgment of the game failure or crash, and in some instances by the provision of compensatory in-game assets. It is expected that such automatic, proactive apology and/or compensation will cause a reduction in the frequency and/or severity of negative reviews recorded by affected players on online platforms following game crashes or failure, which can negatively affect a game's reputation.

One aspect disclosed by the above-described example embodiments thus includes a method comprising:

identifying a failure event in a computer-implemented online game played by a player on a client device, the failure event comprising, at least, disturbance of gameplay by the player caused by malfunctioning of one or more application components executing the game; and

in an automated process performed by one or more processors in response to the failure event, presenting on the client device a failure acknowledgment communication indicating acknowledgment of the failure event by a host of the game.

Note that “presenting” a communication on the client device encompasses both displaying the communication on the client device, and causing display of the communication on the client device, e.g., by instructions sent from a game management system to the client device.

The method may further comprise providing to the player a failure compensation having in-game value, and presenting on the client device a compensation message indicating that provision of the failure compensation is a result of the failure event. In some embodiments, the failure compensation comprises virtual in-game currency. Instead, or in addition, the failure compensation may comprise non-currency in-game assets or resources. The compensation message may form part of the failure acknowledgment communication.

The failure compensation may have a predefined non-variable value, so that different players with different attributes are provided with respective failure compensations that are equal in value, in response to experiencing respective failure events. In other embodiments, the method may further comprise accessing player-specific information for the player regarding the failure event, and calculating a compensation value for the failure compensation based at least in part on the player-specific information.

In instances where variable failure compensation may be provided based on player-specific or failure-specific attributes, the method may further comprise, in response to a further failure event experienced by a further player:

accessing player-specific information for the further player regarding the further failure event; and

calculating a further compensation value for a corresponding failure compensation based at least in part on the player-specific information of the further player, the further compensation value being different from the compensation value associated with the player.

The method may comprise automatically launching an interactive failure acknowledgment process in response to the failure event, the displaying of the failure acknowledgment communication forming part of the interactive failure acknowledgment process. The interactive failure acknowledgment process may include presenting on the client device a player-selectable data-gathering option for allowing collection from the client device of failure data corresponding to the failure event, and, in response to player selection of the data-gathering option, collecting the failure data from the client device. In such case, the method may further comprise offering to the player a failure compensation as incentive for selecting the data-gathering option, provision of the failure compensation to the player being conditional upon selection of the data-gathering option.

Another aspect disclosed by the example embodiments includes a system comprising:

a failure management module configured to identify a failure event in a computer-implemented online game played by a player on a client device, the failure event comprising, at least, disturbance of gameplay caused by malfunctioning of one or more application components executing the game; and

a failure acknowledgment module configured automatically to present on the client device, in response to identification of the failure event, a failure acknowledgment communication indicating acknowledgment of the failure event by a host of the game.

The system may further comprise a failure compensation engine to calculate and/or provide a failure compensation to the player to lessen or ameliorate player frustration and/or in-game losses resulting from the failure event.

### Data Flow

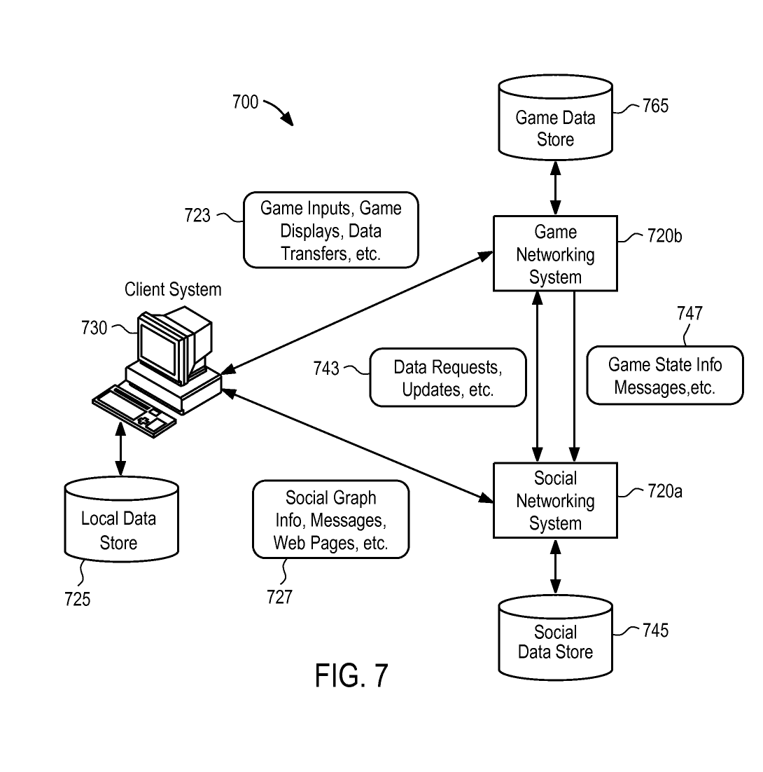

FIG. 7 illustrates an example data flow between the components of an example system 700. In particular embodiments, system 700 can include client system 730, social networking system 720a, and game networking system 720b. A system 300 such as that described with reference to FIG. 3 may be provided by the client system 730, the social networking system 720a, or the game networking system 720b, or by any combination of these systems. The components of system 700 can be connected to each other in any suitable configuration, using any suitable type of connection. The components may be connected directly or over any suitable network. Client system 730, social networking system 720a, and game networking system 720b can each have one or more corresponding data stores such as local data store 725, social data store 745, and game data store 765, respectively. Social networking system 720a and game networking system 720b can also have one or more servers that can communicate with client system 730 over an appropriate network. Social networking system 720a and game networking system 720b can have, for example, one or more Internet servers for communicating with client system 730 via the Internet. Similarly, social networking system 720a and game networking system 720b can have one or more mobile servers for communicating with client system 730 via a mobile network (e.g., GSM, PCS, Wi-Fi, WPAN, etc.). In some embodiments, one server may be able to communicate with client system 730 over both the Internet and a mobile network. In other embodiments, separate servers can be used.

Client system 730 can receive and transmit data 723 to and from game networking system 720b. This data 723 can include, for example, webpages, messages, game inputs, game displays, HTTP packets, data requests, transaction information, updates, and other suitable data. At some other time, or at the same time, game networking system 720b can communicate data 743, 747 (e.g., game state information, game system account information, page info, messages, data requests, updates, etc.) with other networking systems, such as social networking system 720a (e.g., Facebook, Myspace, etc.). Client system 730 can also receive and transmit data 727 to and from social networking system 720a. This data 727 can include, for example, webpages, messages, social graph information, social network displays, HTTP packets, data requests, transaction information, updates, and other suitable data.

Communication between client system 730, social networking system 720a, and game networking system 720b can occur over any appropriate electronic communication medium or network using any suitable communications protocols. For example, client system 730, as well as various servers of the systems described herein, may include Transport Control Protocol/Internet Protocol (TCP/IP) networking stacks to provide for datagram and transport functions. Of course, any other suitable network and transport layer protocols can be utilized.

In addition, hosts or end-systems described herein may use a variety of higher layer communications protocols, including client-server (or request-response) protocols, such as HTTP, other communications protocols, such as HTTP-S, FTP, SNMP, TELNET, and a number of other protocols may be used. In addition, a server in one interaction context may be a client in another interaction context. In particular embodiments, the information transmitted between hosts may be formatted as HyperText Markup Language (HTML) documents. Other structured document languages or formats can be used, such as XML and the like. Executable code objects, such as JavaScript and ActionScript, can also be embedded in the structured documents.

In some client-server protocols, such as the use of HTML over HTTP, a server generally transmits a response to a request from a client. The response may comprise one or more data objects. For example, the response may comprise a first data object, followed by subsequently transmitted data objects. In particular embodiments, a client request may cause a server to respond with a first data object, such as an HTML page, which itself refers to other data objects. A client application, such as a browser, will request these additional data objects as it parses or otherwise processes the first data object.

In particular embodiments, an instance of an online game can be stored as a set of game state parameters that characterize the state of various in-game objects, such as, for example, player character state parameters, non-player character parameters, and virtual item parameters. In particular embodiments, game state is maintained in a database as a serialized, unstructured string of text data as a so-called binary large object (BLOB). When a player accesses an online game on game networking system 720b, the BLOB containing the game state for the instance corresponding to the player can be transmitted to client system 730 for use by a client-side executed object to process. In particular embodiments, the client-side executable may be a Flash-based game, which can de-serialize the game state data in the BLOB. As a player plays the game, the game logic implemented at client system 730 maintains and modifies the various game state parameters locally. The client-side game logic may also batch game events, such as mouse clicks, and transmit these events to game networking system 720b. Game networking system 720b may itself operate by retrieving a copy of the BLOB from a database or an intermediate memory cache (memcache) layer. Game networking system 720b can also de-serialize the BLOB to resolve the game state parameters and execute its own game logic based on the events in the batch file of events transmitted by the client to synchronize the game state on the server side. Game networking system 720b may then re-serialize the game state, now modified, into a BLOB, and pass this to a memory cache layer for lazy updates to a persistent database.

With a client-server environment in which the online games may run, one server system, such as game networking system 720b, may support multiple client systems 730. At any given time, there may be multiple players at multiple client systems 730 all playing the same online game. In practice, the number of players playing the same game at the same time may be very large. As the game progresses with each player, multiple players may provide different inputs to the online game at their respective client systems 730, and multiple client systems 730 may transmit multiple player inputs and/or game events to game networking system 720b for further processing. In addition, multiple client systems 730 may transmit other types of application data to game networking system 720b.

In particular embodiments, a computer-implemented game may be a text-based or turn-based game implemented as a series of web pages that are generated after a player selects one or more actions to perform. The web pages may be displayed in a browser client executed on client system 730. As an example and not by way of limitation, a client application downloaded to client system 730 may operate to serve a set of webpages to a player. As another example and not by way of limitation, a computer-implemented game may be an animated or rendered game executable as a stand-alone application or within the context of a webpage or other structured document. In particular embodiments, the computer-implemented game may be implemented using Adobe Flash-based technologies. As an example and not by way of limitation, a game may be fully or partially implemented as a Small Web Format (SWF) object that is embedded in a web page and executable by a Flash media player plug-in. In particular embodiments, one or more described webpages may be associated with or accessed by social networking system 720a. This disclosure contemplates using any suitable application for the retrieval and rendering of structured documents hosted by any suitable network-addressable resource or website.

Application event data of a game is any data relevant to the game (e.g., player inputs). In particular embodiments, each application datum may have a name and a value, and the value of the application datum may change (i.e., be updated) at any time. When an update to an application datum occurs at client system 730, either caused by an action of a game player or by the game logic itself, client system 730 may need to inform game networking system 720b of the update. For example, if the game is a farming game with a harvest mechanic (such as Zynga FarmVille), an event can correspond to a player clicking on a parcel of land to harvest a crop. In such an instance, the application event data may identify an event or action (e.g., harvest) and an object in the game to which the event or action applies. For illustration purposes and not by way of limitation, system 700 is discussed in reference to updating a multi-player online game hosted on a network-addressable system (such as, for example, social networking system 720a or game networking system 720b), where an instance of the online game is executed remotely on a client system 730, which then transmits application event data to the hosting system such that the remote game server synchronizes the game state associated with the instance executed by the client system 730.

In a particular embodiment, one or more objects of a game may be represented as an Adobe Flash object. Flash may manipulate vector and raster graphics, and supports bidirectional streaming of audio and video. “Flash” may mean the authoring environment, the player, or the application files. In particular embodiments, client system 730 may include a Flash client. The Flash client may be configured to receive and run Flash application or game object code from any suitable networking system (such as, for example, social networking system 720a or game networking system 720b). In particular embodiments, the Flash client may be run in a browser client executed on client system 730. A player can interact with Flash objects using client system 730 and the Flash client. The Flash objects can represent a variety of in-game objects. Thus, the player may perform various in-game actions on various in-game objects by making various changes and updates to the associated Flash objects. In particular embodiments, in-game actions can be initiated by clicking or similarly interacting with a Flash object that represents a particular in-game object. For example, a player can interact with a Flash object to use, move, rotate, delete, attack, shoot, or harvest an in-game object. This disclosure contemplates performing any suitable in-game action by interacting with any suitable Flash object. In particular embodiments, when the player makes a change to a Flash object representing an in-game object, the client-executed game logic may update one or more game state parameters associated with the in-game object. To ensure synchronization between the Flash object shown to the player at client system 730 and the game networking system 720b, the Flash client may send the events that caused the game state changes to the in-game object to game networking system 720b. However, to expedite the processing and hence the speed of the overall gaming experience, the Flash client may collect a batch of some number of events or updates into a batch file. The number of events or updates may be determined by the Flash client dynamically or determined by game networking system 720b based on server loads or other factors. For example, client system 730 may send a batch file to game networking system 720b whenever 50 updates have been collected or after a threshold period of time, such as every minute.

As used herein, the term “application event data” may refer to any data relevant to a computer-implemented game application that may affect one or more game state parameters, including, for example and without limitation, changes to player data or metadata, changes to player social connections or contacts, player inputs to the game, and events generated by the game logic. In particular embodiments, each application datum may have a name and a value. The value of an application datum may change at any time in response to the game play of a player or in response to the game engine (e.g., based on the game logic). In particular embodiments, an application data update occurs when the value of a specific application datum is changed. In particular embodiments, each application event datum may include an action or event name and a value (such as an object identifier). Thus, each application datum may be represented as a name-value pair in the batch file. The batch file may include a collection of name-value pairs representing the application data that have been updated at client system 730. In particular embodiments, the batch file may be a text file and the name-value pairs may be in string format.

In particular embodiments, when a player plays an online game on client system 730, game networking system 720b may serialize all the game-related data, including, for example and without limitation, game states, game events, and user inputs, for this particular user and this particular game into a BLOB and store the BLOB in a database. The BLOB may be associated with an identifier that indicates that the BLOB contains the serialized game-related data for a particular player and a particular online game. In particular embodiments, while a player is not playing the online game, the corresponding BLOB may be stored in the database. This enables a player to stop playing the game at any time without losing the current state of the game that the player is in. When a player resumes playing the game next time, game networking system 720b may retrieve the corresponding BLOB from the database to determine the most-recent values of the game-related data. In particular embodiments, while a player is playing the online game, game networking system 720b may also load the corresponding BLOB into a memory cache so that the game system may have faster access to the BLOB and the game-related data contained therein.

### Systems and Methods

In particular embodiments, one or more described webpages may be associated with a networking system or networking service. However, alternate embodiments may have application to the retrieval and rendering of structured documents hosted by any type of network addressable resource or web site. Additionally, as used herein, a user may be an individual, a group, or an entity (such as a business or third party application).

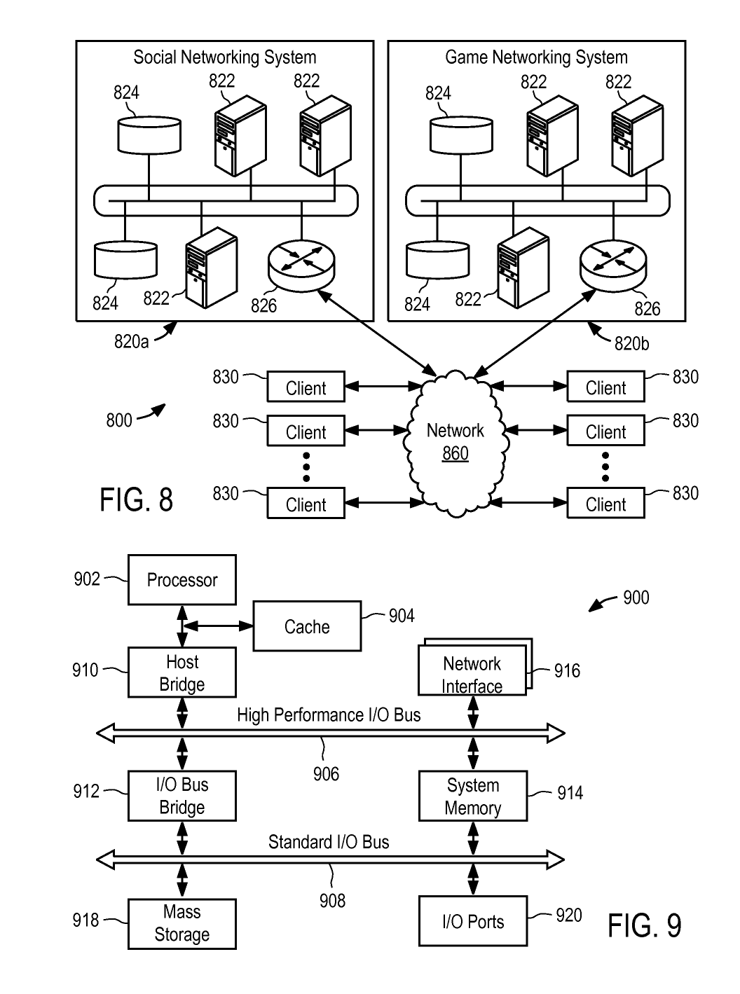

Particular embodiments may operate in a WAN environment, such as the Internet, including multiple network addressable systems. FIG. 8 illustrates an example network environment 800, in which various example embodiments may operate. Network cloud 860 generally represents one or more interconnected networks, over which the systems and hosts described herein can communicate. Network cloud 860 may include packet-based WAN (such as the Internet), private networks, wireless networks, satellite networks, cellular networks, paging networks, and the like. As FIG. 8 illustrates, particular embodiments may operate in a network environment comprising one or more networking systems, such as social networking system 820a, game networking system 820b, and one or more client systems 830. The components of social networking system 820a and game networking system 820b operate analogously; as such, hereinafter they may be referred to simply as networking system 820. Client systems 830 are operably connected to the network environment 800 via a network service provider, a wireless carrier, or any other suitable means.

Networking system 820 is a network addressable system that, in various example embodiments, comprises one or more physical servers 822 and data stores 824. The one or more physical servers 822 are operably connected to network cloud 860 via, by way of example, a set of routers and/or networking switches 826. In an example embodiment, the functionality hosted by the one or more physical servers 822 may include web or HTTP servers, FTP servers, and, without limitation, webpages and applications implemented using Common Gateway Interface (CGI) script, PHP Hyper-text Preprocessor (PHP), Active Server Pages (ASP), HTML, XML, Java, JavaScript, Asynchronous JavaScript and XML (AJAX), Flash, ActionScript, and the like.

Physical servers 822 may host functionality directed to the operations of networking system 820. Hereinafter servers 822 may be referred to as server 822, although server 822 may include numerous servers hosting, for example, networking system 820, as well as other content distribution servers, data stores, and databases. Data store 824 may store content and data relating to, and enabling, operation of networking system 820 as digital data objects. A data object, in particular embodiments, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, and the like. Logically, data store 824 corresponds to one or more of a variety of separate and integrated databases, such as relational databases and object-oriented databases that maintain information as an integrated collection of logically related records or files stored on one or more physical systems. Structurally, data store 824 may generally include one or more of a large class of data storage and management systems. In particular embodiments, data store 824 may be implemented by any suitable physical system(s) including components, such as one or more database servers, mass storage media, media library systems, storage area networks, data storage clouds, and the like. In one example embodiment, data store 824 includes one or more servers, databases (e.g., MySQL), and/or data warehouses. Data store 824 may include data associated with different networking system 820 users and/or client systems 830.

Client system 830 is generally a computer or computing device including functionality for communicating (e.g., remotely) over a computer network. Client system 830 may be a desktop computer, laptop computer, personal digital assistant (PDA), in- or out-of-car navigation system, smart phone or other cellular or mobile phone, or mobile gaming device, among other suitable computing devices. Client system 830 may execute one or more client applications, such as a web browser (e.g., Microsoft Internet Explorer, Mozilla Firefox, Apple Safari, Google Chrome, and Opera), to access and view content over a computer network. In particular embodiments, the client applications allow a user of client system 830 to enter addresses of specific network resources to be retrieved, such as resources hosted by networking system 820. These addresses can be uniform resource locators (URLs) and the like. In addition, once a page or other resource has been retrieved, the client applications may provide access to other pages or records when the user “clicks” on hyperlinks to other resources. By way of example, such hyperlinks may be located within the webpages and provide an automated way for the user to enter the URL of another page and to retrieve that page.

A webpage or resource embedded within a webpage, which may itself include multiple embedded resources, may include data records, such as plain textual information, or more complex digitally encoded multimedia content, such as software programs or other code objects, graphics, images, audio signals, videos, and so forth. One prevalent markup language for creating webpages is HTML. Other common web browser-supported languages and technologies include XML, the Extensible Hypertext Markup Language (XHTML), JavaScript, Flash, ActionScript, Cascading Style Sheet (CSS), and, frequently, Java. By way of example, HTML enables a page developer to create a structured document by denoting structural semantics for text and links, as well as images, web applications, and other objects that can be embedded within the page. Generally, a webpage may be delivered to a client as a static document; however, through the use of web elements embedded in the page, an interactive experience may be achieved with the page or a sequence of pages. During a user session at the client, the web browser interprets and displays the pages and associated resources received or retrieved from the website hosting the page, as well as, potentially, resources from other websites.

When a user at a client system 830 desires to view a particular webpage (hereinafter also referred to as target structured document) hosted by networking system 820, the user's web browser, or other document rendering engine or suitable client application, formulates and transmits a request to networking system 820. The request generally includes a URL or other document identifier as well as metadata or other information. By way of example, the request may include information identifying the user, such as a user ID, as well as information identifying or characterizing the web browser or operating system running on the user's client system 830. The request may also include location information identifying a geographic location of the user's client system or a logical network location of the user's client system 830. The request may also include a timestamp identifying when the request was transmitted.

Although the example network environment 800 described above and illustrated in FIG. 8 is described with respect to social networking system 820a and game networking system 820b, this disclosure encompasses any suitable network environment using any suitable systems. As an example and not by way of limitation, the network environment may include online media systems, online reviewing systems, online search engines, online advertising systems, or any combination of two or more such systems.

FIG. 9 illustrates an example computing system architecture, which may be used to implement a server 822 or a client system 830 (FIG. 8). In one embodiment, hardware system 900 comprises a processor 902, a cache memory 904, and one or more executable modules and drivers, stored on a tangible computer readable medium, directed to the functions described herein. Additionally, hardware system 900 may include a high performance input/output (I/O) bus 906 and a standard I/O bus 908. A host bridge 910 may couple processor 902 to high performance I/O bus 906, whereas I/O bus bridge 912 couples the two buses 906 and 908 to each other. A system memory 914 and one or more network/communication interfaces 916 may couple to bus 906. Hardware system 900 may further include video memory (not shown) and a display device coupled to the video memory. Mass storage 918 and I/O ports 920 may couple to bus 908. Hardware system 900 may optionally include a keyboard, a pointing device, and a display device (not shown) coupled to bus 908. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 900 are described in greater detail below. In particular, network interface 916 provides communication between hardware system 900 and any of a wide range of networks, such as an Ethernet (e.g., IEEE 802.3) network, a backplane, and the like. Mass storage 918 provides permanent storage for the data and programming instructions to perform the above-described functions implemented in servers 822 (FIG. 8), whereas system memory 914 (e.g., DRAM) provides temporary storage for the data and programming instructions when executed by processor 902. I/O ports 920 are one or more serial and/or parallel communication ports that provide communication between additional peripheral devices, which may be coupled to hardware system 900.

Hardware system 900 may include a variety of system architectures, and various components of hardware system 900 may be rearranged. For example, cache memory 904 may be on-chip with processor 902. Alternatively, cache memory 904 and processor 902 may be packed together as a “processor module,” with processor 902 being referred to as the “processor core.” Furthermore, certain embodiments of the present disclosure may not require nor include all of the above components. For example, the peripheral devices shown coupled to standard I/O bus 908 may couple to high performance I/O bus 906. In addition, in some embodiments, only a single bus may exist, with the components of hardware system 900 being coupled to the single bus. Furthermore, hardware system 900 may include additional components, such as additional processors, storage devices, or memories.

An operating system manages and controls the operation of hardware system 900, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Of course, other embodiments are possible. For example, the functions described herein may be implemented in firmware or on an application-specific integrated circuit (ASIC).

Furthermore, the above-described elements and operations can be comprised of instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions are operational when executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

### Modules, Components, and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an ASIC) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., Application Program Interfaces (APIs).)

### Miscellaneous

One or more features from any embodiment may be combined with one or more features of any other embodiment without departing from the scope of the disclosure.

A recitation of “a,” “an,” or “the” is intended to mean “one or more” unless specifically indicated to the contrary.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and “website” may be used interchangeably and additionally may refer to a custom or generalized API on a device, such as a mobile device (e.g., a cellular phone, smart phone, personal GPS, personal digital assistant, personal gaming device), that makes API calls directly to a server. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

What is claimed is:

1. A method comprising:
identifying a failure event in a computer-implemented online game played by a player on a client device, the failure event comprising, at least, disturbance of player gameplay caused by malfunctioning of one or more application components executing the game; and
in an automated process performed by one or more processors in response to the failure event, presenting on the client device a failure acknowledgment communication indicating acknowledgment of the failure event by a host of the game.

2. The method of claim 1, further comprising:
providing to the player a failure compensation having in-game value; and
presenting on the client device a compensation message indicating that provision of the failure compensation is a result of the failure event.

3. The method of claim 2, wherein the failure compensation comprises virtual in-game currency.

4. The method of claim 2, wherein the compensation message forms part of the failure acknowledgment communication.

5. The method of claim 2, wherein the failure compensation has a predefined non-variable value, so that different players with different attributes are provided with respective failure compensations that are equal in value, in response to experiencing respective failure events.

6. The method of claim 2, further comprising:
accessing player-specific information for the player regarding the failure event; and
calculating a compensation value for the failure compensation based at least in part on the player-specific information.

7. The method of claim 6, further comprising in response to a further failure event experienced by a further player:
accessing player-specific information for the further player regarding the further failure event; and
calculating a further compensation value for a corresponding failure compensation based at least in part on the player-specific information of the further player, the further compensation value being different from the compensation value associated with the player.

8. The method of claim 1, further comprising automatically launching an interactive failure acknowledgment process in response to the failure event, the displaying of the failure acknowledgment communication forming part of the interactive failure acknowledgment process.

9. The method of claim 8, wherein the interactive failure acknowledgment process includes:
presenting on the client device a player-selectable data-gathering option for allowing collection from the client device of failure data corresponding to the failure event; and
in response to player selection of the data-gathering option, collecting the failure data from the client device.

10. The method of claim 9, further comprising offering to the player a failure compensation as incentive for selecting the data-gathering option, provision of the failure compensation to the player being conditional upon selection of the data-gathering option.

11. A system comprising:
a failure management module configured to identify a failure event in a computer-implemented online game played by a player on a client device, the failure event comprising, at least, disturbance of player gameplay caused by malfunctioning of one or more application components executing the game; and
a failure acknowledgment module configured automatically to present on the client device, in response to identification of the failure event, a failure acknowledgment communication indicating acknowledgment of the failure event by a host of the game.

12. The system of claim 11, further comprising a failure compensation engine configured to provide to the player a failure compensation having in-game value, the failure acknowledgment module being configured to present on the client device a compensation message indicating that provision of the failure compensation is a result of the failure event.

13. The system of claim 12, wherein the failure compensation comprises an in-game asset.

14. The system of claim 12, wherein the failure compensation engine is configured such that the failure compensation has a predefined non-variable value, so that different players with different attributes are provided with respective failure compensations that are equal in value, in response to experiencing respective failure events.

15. The system of claim 12, further comprising a player data module to access player-specific information, wherein the failure compensation engine is configured to calculate a compensation value for the failure compensation based at least in part on the player-specific information.

16. The system of claim 11, wherein the failure management module is configured to automatically launch an interactive failure acknowledgment process in response to the failure event, the displaying of the failure acknowledgment communication forming part of the interactive failure acknowledgment process.

17. The system of claim 16, wherein the failure management module is configured to manage the interactive failure acknowledgment process such that it includes:
presenting on the client device a player-selectable data-gathering option for allowing collection from the client device of failure data corresponding to the failure event; and
in response to player selection of the data-gathering option, collecting the failure data from the client device.

18. The system of claim 17, wherein the failure management module is further configured to offer to the player a failure compensation as incentive for selecting the data-gathering option, provision of the failure compensation to the player being conditional upon selection of the data-gathering option.

19. A non-transitory computer readable storage medium including instructions for causing a machine executing the instructions to perform operations comprising:
identifying a failure event in a computer-implemented online game played by a player on a client device, the failure event comprising, at least, disturbance of player gameplay by the player caused by malfunctioning of one or more application components executing the game; and
in an automated process performed by one or more processors in response to the failure event, presenting on the client device a failure acknowledgment communication indicating acknowledgment of the failure event by a host of the game.
